(19) United States
(12) Patent Application Publication
(10) Pub. No.: US 2016/0086151 A1
(43) Pub. Date: Mar. 24, 2016

(54) SYSTEM AND METHOD FOR MANAGING A PREPAYMENT ACCOUNT AND ASSOCIATED PREPAYMENT MESSAGES

(71) Applicant: Tencent Technology (Shenzhen) Company Limited, Shenzhen (CN)

(72) Inventors: Dongming Xia, Shenzhen (CN); Ziying Ke, Shenzhen (CN); Yanghui Xu, Shenzhen (CN)

(21) Appl. No.: 14/959,506

(22) Filed: Dec. 4, 2015

Related U.S. Application Data
(63) Continuation of application No. PCT/CN2014/089639, filed on Oct. 28, 2014.

(30) Foreign Application Priority Data
Oct. 29, 2013 (CN) 201310522229.7

(51) Int. Cl. G06Q 20/28; G06Q 40/02; G06Q 50/00; G06Q 20/38

(52) U.S. Cl. CPC G06Q 20/28; G06Q 20/385; G06Q 20/3829; G06Q 40/02; G06Q 50/01

(57) ABSTRACT

A method is provided for mobile payment. The method is performed at a social networking system and includes receiving, from a first client device, a request to establish a prepayment account at the social networking system. In response to the received request, the prepayment account is established. The method further includes receiving a payment request from the first client device and, in response to the payment request, generating a unique identifier corresponding to the payment request. The unique identifier is sent to the first client device. The method further includes receiving, from a respective merchant, a transaction request that includes information corresponding to the unique identifier, a transaction amount, and an identifier of a user account of the respective merchant. The method further includes initiating transfer of the transaction amount from the prepayment account to the user account of the respective merchant.

### RELATED APPLICATIONS

This application is a continuation application of PCT Patent Application No. PCT/CN2014/089639, entitled “SYSTEM AND METHOD FOR MANAGING A PREPAYMENT ACCOUNT AND ASSOCIATED PREPAYMENT MESSAGES” filed on Oct. 28, 2014, which claims priority to Chinese Patent Application No. 201310522229.7, entitled “SYSTEM AND METHOD FOR MANAGING A PREPAYMENT ACCOUNT AND ASSOCIATED PREPAYMENT MESSAGES,” filed on Oct. 29, 2013, both of which are incorporated by reference in their entirety.

### TECHNICAL FIELD

The disclosed implementations relate generally to the field of secure payments, and in particular, to methods of prepayment using a social networking system.

### BACKGROUND

Prepaid cards (e.g., gift cards or preloaded cash cards) are convenient for consumers and merchants alike. For consumers, prepaid cards eliminate the need to carry cash (e.g., especially unwieldy coins), make convenient gifts, and can be obtained even by those consumers who are not eligible to borrow money in the form of a credit card. Merchants, too, are benefited by gift cards whose use restricted to the merchants as the purchase of a gift card represents a commitment to future purchases.

But there are downsides to prepaid cards. The consumer still has to carry a physical card, which is inconvenient in the modern age of smart phones and other electronic devices. In some circumstances, it may be difficult for a consumer to check the remaining balance on a prepaid card. Also, while more secure than cash, a lost or stolen prepaid card can often be used by anyone. Merchants, too, are burdened by bookkeeping requirements needed to maintain their own prepaid cards (e.g., gift cards).

### SUMMARY

To address the aforementioned problems, a method is provided for handling secure prepayments over a social networking system (or another network) using a unique identifier (e.g., a barcode such as a QR code) in lieu of a physical prepaid card. In particular, the method provides a manner in which a consumer can safely pay a vendor while the consumer is optionally in an “offline” state. The method includes receiving, from a first client device of a respective consumer, a request to establish a prepayment account at the social networking system. The request includes an identifier of a user account of the respective consumer at the social networking system. In response to the received request, the prepayment account is established. The method further includes receiving a payment request from the first client device. In response to the payment request, a unique identifier corresponding to the payment request is generated and sent to the first client device. The method still further includes receiving, from a second client device of a respective merchant, a transaction request that includes information corresponding to the unique identifier, a transaction amount, and an identifier of a user account of the respective merchant at the social networking system. The method still further includes initiating transfer of the transaction amount from the prepayment account to the user account of the respective merchant at the social networking system.

In another aspect of the present disclosure, a social networking server system is provided for handling secure prepayments using a unique identifier (e.g., a barcode such as a QR code) in lieu of a physical prepaid card. In particular, the social networking server system allows a consumer to safely pay a vendor while the consumer is optionally in an “offline” state. To this end, the social networking server system receives, from a first client device of a respective consumer, a request to establish a prepayment account at the social networking system. The request includes an identifier of a user account of the respective consumer at the social networking system. In response to the received request, the prepayment account is established by the social networking server system. The social networking server system then receives a payment request from the first client device. In response to the payment request, a unique identifier corresponding to the payment request is generated and sent to the first client device by the social networking server system. The social networking server system receives, from a second client device of a respective merchant, a transaction request that includes information corresponding to the unique identifier, a transaction amount, and an identifier of a user account of the respective merchant at the social networking system. The social networking server system initiates transfer of the transaction amount from the prepayment account to the user account of the respective merchant at the social networking system.

In another aspect of the present disclosure, a non-transitory computer readable storage medium is provided for instructing a social networking server system to handle secure prepayments using a unique identifier (e.g., a barcode such as a QR code) in lieu of a physical prepaid card. In particular, the instructions allow a consumer to safely pay a vendor while the consumer is optionally in an “offline” state. To this end, the non-transitory computer readable storage medium includes instructions that cause the social networking server system to receive, from a first client device of a respective consumer, a request to establish a prepayment account at the social networking system. The request includes an identifier of a user account of the respective consumer at the social networking system. The instructions also cause the social networking server system to, in response to the received request, establish the prepayment account. The instructions also cause the social networking server system to receive a payment request from the first client device. In response to the payment request, the instructions cause the social networking server system to generate a unique identifier corresponding to the payment request and send the unique identifier to the first client device. The instructions also cause the social networking server system to receive, from a second client device of a respective merchant, a transaction request that includes information corresponding to the unique identifier, a transaction amount, and an identifier of a user account of the respective merchant at the social networking system. The instructions also cause the social networking server system to initiate transfer of the transaction amount from the prepayment account to the user account of the respective merchant at the social networking system.

In another aspect of the present disclosure, to address the aforementioned problems, some implementations provide a non-transitory computer readable storage medium storing one or more programs. The one or more programs comprise instructions, which when executed by a social networking server system with one or more processors and memory, cause the social networking server system to perform any of the methods provided herein.

In yet another aspect of the present disclosure, to address the aforementioned problems, some implementations provide a social networking server system. The social networking server system includes one or more processors, memory, and one or more programs. The one or more programs are stored in memory and configured to be executed by the one or more processors. The one or more programs include an operating system and instructions that when executed by the one or more processors cause the social networking server system to perform any of the methods provided herein.

### BRIEF DESCRIPTION OF DRAWINGS

The aforementioned implementation of the disclosure as well as additional implementations will be more clearly understood as a result of the following detailed description of the various aspects of the disclosure when taken in conjunction with the drawings.

FIG. 1 is a flow schematic view of a prepayment information management method, in accordance with some embodiments.

FIG. 2 is another flow schematic view of the prepayment information management method, in accordance with some embodiments.

FIG. 3 is a system architecture of a prepayment system, in accordance with some embodiments.

FIG. 4 is a server-client environment that includes a social media network over which secure payments are made, in accordance with some embodiments.

FIGS. 5A-5D illustrate examples of user interfaces for making secure payments, in accordance with some embodiments.

FIGS. 6A-6D a flowchart illustrating a method of handling a secure payment over a social media network, in accordance with some embodiments.

FIG. 7 is a structural block diagram of a client, in accordance with some embodiments.

FIG. 8 is a structural block diagram of a server, in accordance with some embodiments.

Like reference numerals refer to corresponding parts throughout the several views of the drawings.

### DETAILED DESCRIPTION

The embodiments described below provide a convenient, secure method of prepayment using a social networking service. In accordance with some embodiments, a consumer who has an established prepayment account with the social networking service can preload funds using a payment request. The social networking system sends the consumer a unique identifier that the consumer can then use to draw from the payment request. For example, in some embodiments, the unique identifier is a QR code that is “texted” to the consumer via the social networking service's mobile application. A merchant's device can photograph the QR code (e.g., using his or her own instance of the mobile app) and transmit information corresponding to the QR code, along with a transaction amount, to the social networking system, which then transfers the funds indicated by the transaction amount from the consumer payment request to an account held by the merchant.

To increase security, several features are described below. Among them, the consumer can, in some embodiments, place constraints (e.g., restrictions) on transactions invoked using the unique identifier, such as temporal constraints, geographical constraints, product constraints, merchant constraints, and the like. In some embodiments, when a consumer attempts a transaction with the unique identifier, the merchant's client device takes a picture of the consumer and transmits the picture to the social networking system for facial recognition (e.g., to assure that the correct user is using the account). The picture is also stored for dispute resolution and fraud prevention at a later time.

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

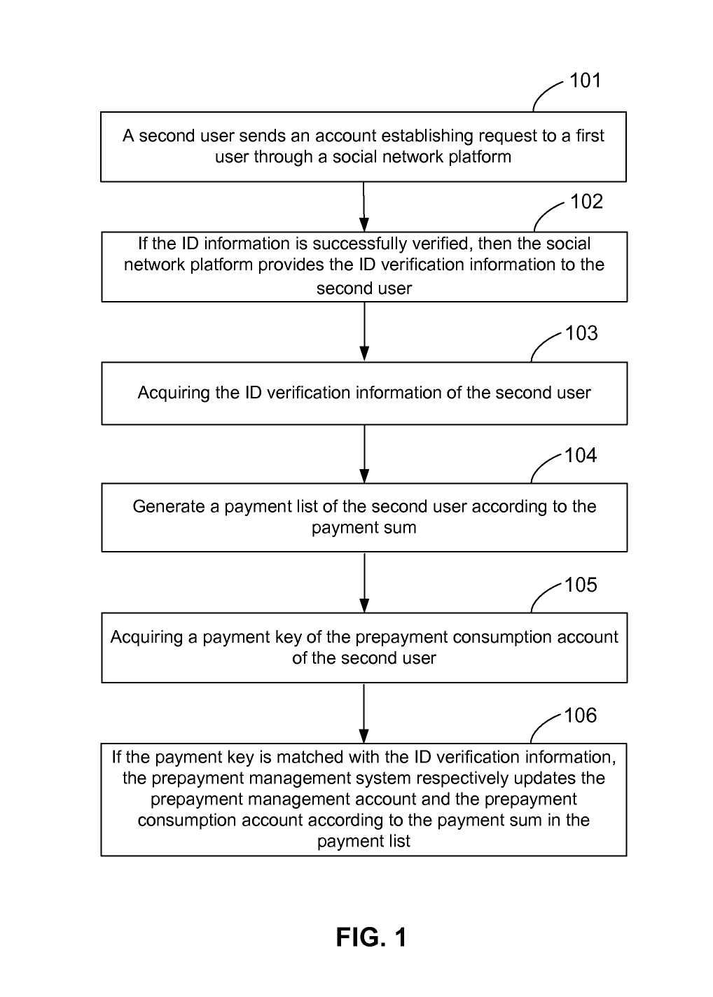

Referring to FIG. 1, a prepayment information management method according to one embodiment of the present application includes the following steps.

Step 101: A second user sends an account-establishing request to a first user through a social network platform.

The second user may send the account-establishing request to the first user through the social network platform, wherein the account-establishing request is used for establishing prepayment account information in a prepayment management account of the first user for the second user.

A merchant user, after receiving the account-establishing request in the social network platform, provides a verification flow for the second user to verify the ID information of the second user. If the ID information is successfully verified, then verification information (for example, one two-dimensional code) corresponding to the second user is generated.

For example, in the embodiment of the present application, the social network platform particularly may be an instant messaging tool, a game interactive tool, or a social tool of a mobile end. Particularly, the social network platform may be WeChat.

Step 102: If the ID information is successfully verified, then the social network platform provides the ID verification information to the second user.

Moreover, a prepayment management system respectively establishes a prepayment management account and a prepayment consumption account for the first user and the second user.

After acquiring the ID verification information, the second user may carry the ID verification information to carry out offline consumption in a physical store of the first user.

For example, the second user may store the ID verification information at such mobile terminals as a mobile phone or a tablet computer, and may also store the ID verification information under the account information of the second user in the social network platform.

For example, supposing the first user is a merchant user, the second user is a consumer user, the consumer user may send an account query request to the merchant user through the social network platform. The merchant user, after receiving the account query request in the social network platform, queries the information of the prepayment consumption account of the consumer user from the prepayment management system according to the account query request, and returns the information of the corresponding prepayment consumption account of the consumer user to the consumer user after acquiring a query result, wherein the information of the prepayment consumption account includes: account balance and historical consumption information.

For example, the consumer user may further send a prepayment recharging request to the merchant user through the social network platform, wherein the prepayment recharging request is used for carrying out a recharging operation on the prepayment management account of the merchant user. The merchant user, after receiving the prepayment recharging request in the social network platform, provides a payment flow for the consumer user according to the prepayment recharging request, so that the consumer user carries out a payment operation according to the payment operation. If the consumer user pays successfully, then information is sent to the prepayment management system so as to respectively update the account balances of the prepayment management account and the prepayment consumption account according to the prepaid sum of the consumer user.

Step 103: Acquiring the ID verification information of the second user.

The first user uses a deduction terminal to acquire the ID verification information of the second user, wherein the first user is a user that receives the prepayment of the second user.

The ID verification information may be provided to the second user respectively through the social network platform or the prepayment management system, and is used for verifying the ID of the second user.

Optionally, the ID verification information may be a two-dimensional code or a bar code. It should be understood that in practical applications, the ID verification information may further include other information that uniquely identifies the information of the consumer user, and will not be limited herein.

For example, the first user may be a merchant user, and the second user may be a consumer user. In practical application, the consumer user may store the ID verification information with such mobile terminals as a mobile phone or a tablet computer, and the like. After the consumer user arrives at the physical store of the merchant user, the consumer user shall show the ID verification information while carrying out prepayment, and the merchant user scans the ID verification information with the deduction terminal.

Due to the existence of the ID verification information, the consumer user while consuming, may not carry a physical card. While for the merchant user, the cost for issuing the physical card is also saved.

Step 104: Generate a payment list of the second user according to the payment sum.

The deduction terminal generates the payment list of the second user according to the payment sum, wherein the payment list includes the ID information of the first user.

For example, after acquiring the ID verification information of the consumer user, the merchant user may input a payment sum on the deduction terminal, so that the deduction terminal generates the payment list of the consumer user according to the payment sum, wherein the payment list includes the ID information of the merchant user, such as a store name or store account number of the merchant.

Step 105: Acquiring a payment key of the prepayment consumption account of the second user.

The deduction terminal acquires the payment key of the prepayment consumption account of the second user, wherein the payment key is set by the second user. Optionally, the payment key may be a character string or a biological characteristic. Further, the biological characteristic may be a fingerprint characteristic or a pupil characteristic. It should be understood that in practical applications, the payment key may include other implementation modes, and will not be limited herein.

For example, after generating the payment list, the merchant user may show the payment list to the consumer user. When the consumer user confirms the payment list is correct, the consumer user may input the payment key on the deduction terminal.

Step 106: If the payment key is matched with the ID verification information, the prepayment management system respectively updates the prepayment management account and the prepayment consumption account according to the payment sum in the payment list.

The prepayment management account is a management account of the first user for receiving the prepayment of the second user, wherein the prepayment management account may include the prepayment information of a plurality of second users.

The prepayment consumption account includes the prepayment information of the second user in the first user, which may include the account balance and the historical consumption record.

For example, after the consumer user provides the payment key, the deduction terminal carries out data communication to the prepayment management system through a network to verify the validity of the payment key. If the payment key is matched with the ID verification information, then the deduction terminal carries out communication with the prepayment management system according to the payment sum set by the merchant user, to perform a deduction operation on the consumer user. Particularly, the deduction terminal respectively deducts a corresponding sum from the prepayment management account of the merchant user and a corresponding sum from the prepayment consumption account of the consumer user, which are the information maintained by the prepayment management system.

The prepayment management system in the prepayment system provided by the embodiment of the present application is deployed at a cloud, is an independent system of a third party, and may be bound with the social network platform to directly import the user information in the social network platform. The merchant may conveniently establish a prepayment system in the prepayment management system with a low cost through the social network platform. While the consumer user may query the prepayment information thereof in real time through the social network platform. Moreover, since the account information in the prepayment system is managed by the third party, the consumption safety is more guaranteed.

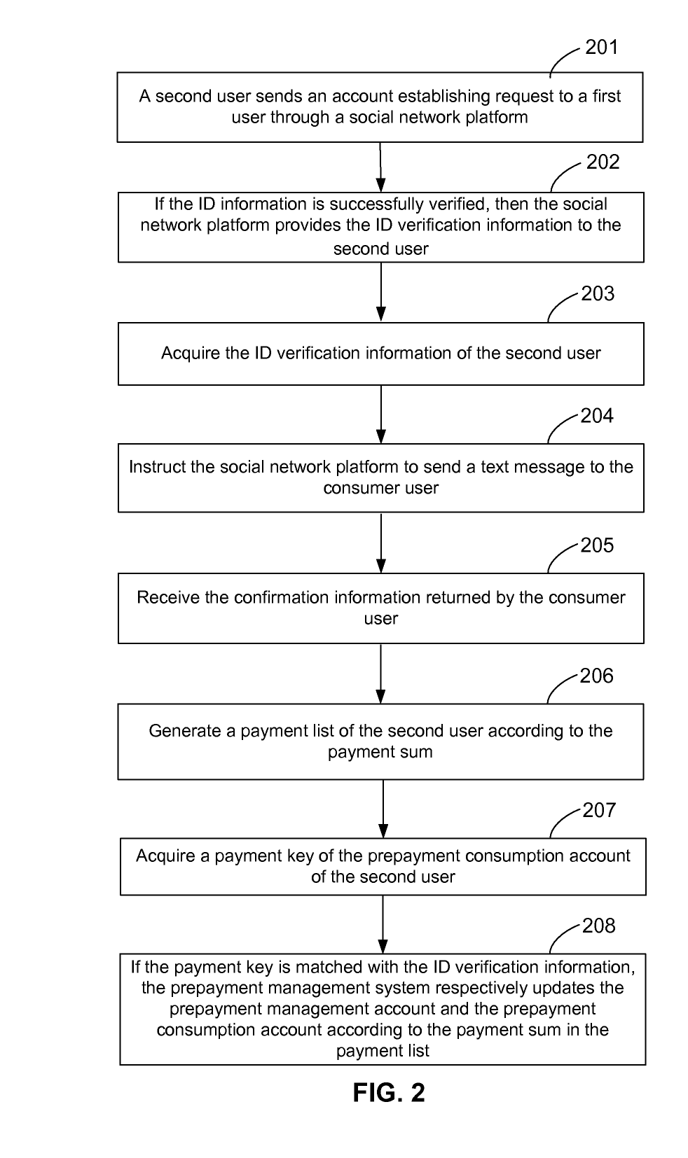

In practical applications, in order to avoid others stealing the ID verification information of the consumer user to consume, the present application provides corresponding solutions. Referring to FIG. 2, a prepayment information management method according to another embodiment of the present application includes the following steps.

Step 201: A second user sends an account-establishing request to a first user through a social network platform.

The second user may send the account-establishing request to the first user through the social network platform, wherein the account-establishing request is used for establishing prepayment account information in a prepayment management account of the first user for the second user.

A merchant user, after receiving the account-establishing request in the social network platform, provides a verification flow for the second user to verify the ID information of the second user. If the ID information is successfully verified, then verification information (for example, one two-dimensional code) corresponding to the second user is generated.

For example, in the embodiment of the present application, the social network platform particularly may be an instant messaging tool, a game interactive tool or a social tool of a mobile end, and the like.

Step 202: If the ID information is successfully verified, then the social network platform provides the ID verification information to the second user.

After acquiring the ID verification information, the second user may carry the ID verification information to carry out offline consumption in a physical store of the first user.

For example, the second user may store the ID verification information at such mobile terminals as a mobile phone or a tablet computer, and may also store the ID verification information under the account information of the second user in the social network platform.

For example, supposing the first user is a merchant user, the second user is a consumer user, the consumer user may send an account query request to the merchant user through the social network platform. The merchant user, after receiving the account query request in the social network platform, queries the information of the prepayment consumption account of the consumer user from the prepayment management system according to the account query request, and returns the information of the corresponding prepayment consumption account of the consumer user to the consumer user after acquiring a query result, wherein the information of the prepayment consumption account includes: account balance and historical consumption information.

For example, the consumer user may further send a prepayment recharging request to the merchant user through the social network platform, wherein the prepayment recharging request is used for carrying out a recharging operation on the prepayment management account of the merchant user. The merchant user, after receiving the prepayment recharging request from the social network platform, provides a payment flow for the consumer user according to the prepayment recharging request, so that the consumer user carries out a payment operation according to the payment operation. If the consumer user pays successfully, then information is sent to the prepayment management system so as to respectively update the account balances of the prepayment management account and the prepayment consumption account according to the prepaid sum of the consumer user.

Step 203: Acquire the ID verification information of the second user.

When the second user consumes in a physical store of the first user, the first user uses a deduction terminal to acquire the ID verification information of the second user, wherein the first user is a user that receives the prepayment of the second user

The ID verification information may be provided to the second user respectively through the social network platform or the prepayment management system, and is used for verifying the ID of the second user.

Optionally, the ID verification information may be a two-dimensional code or a bar code. It should be understood that in practical applications, the ID verification information may further be other information that uniquely identifies the information of the consumer user, and will not be limited herein.

Step 204: Instruct the social network platform to send a text message to the consumer user.

When the second user is consuming, the social network platform is instructed to send the short message to the second user after the first user scans the ID verification information with the deduction terminal, wherein the short message is used for requesting the user to return confirmation information of the current ongoing consumption.

Step 205: Receive the confirmation information returned by the consumer user.

The second user may receive the short message with a mobile phone, and reply the short message to make confirmation. The social network platform or the prepayment management system, after receiving the confirmation information returned by the second user, authorizes the deduction terminal to generate a payment list of the consumer user according to the payment sum.

Step 206: Generate a payment list of the second user according to the payment sum.

The deduction terminal generates the payment list of the second user according to the payment sum, wherein the payment list includes the ID information of the first user.

Step 207: Acquire a payment key of the prepayment consumption account of the second user.

The deduction terminal acquires the payment key of the prepayment consumption account of the second user, wherein the payment key is set by the deduction terminal. Optionally, the payment key may be a character string or a biological characteristic. Further, the biological characteristic may be a fingerprint characteristic or a pupil characteristic. It should be understood that in practical applications, the payment key may include other implementation modes, and will not be limited herein.

Step 208: If the payment key is matched with the ID verification information, the prepayment management system respectively updates the prepayment management account and the prepayment consumption account according to the payment sum in the payment list.

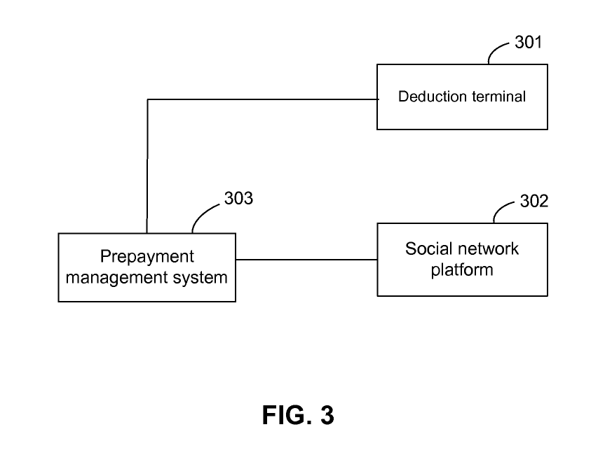

The prepayment system for carrying out the prepayment information management method is described hereinafter. Referring to FIG. 3, the prepayment system according to one embodiment of the present application includes: a deduction terminal 301, a social network platform 302, and a prepayment management system 303.

The social network platform is used for providing and managing network ID information of a first user and a second user, wherein the first user is a user receiving the prepayment of the second user, receiving an account-establishing request sent by the second user, verifying the ID information of the second user, and if the ID information is successfully verified, generating ID verification information corresponding to the second user, and providing the ID verification information to the second user.

In the embodiment of the present application, the social network platform is a platform for people to perform data interaction through network, and particularly may be an instant messaging tool, a game interactive tool, or a social tool of a mobile end, and the like.

Particularly, the first user may send different types of medium information to the second user by means of the communication convenience of the social network platform, wherein the medium information may include: text information, voice information or image information, and the like. Through sending the medium information, the store information and commodities of the first user may be reached to the second user from multiple ways, thus being beneficial for interaction between the first user and the second user, improve the understanding of the second user on the first user, and increase the stickiness of the second user.

In addition, the social network platform may further provide the first user with convenient management information of the second user. The account balances and historical consumption information of different users are clear at a glance through the data interaction between a cloud and the prepayment management system, so that the self list management of the first user is not needed, thus greatly improving the operation convenience of the first user.

For example, in the embodiment of the present application, the social network platform particularly may be an instant messaging tool, a game interactive tool or a social tool of a mobile end, and the like.

The prepayment management system is used for, after the ID information is successfully verified, respectively establishing and managing the prepayment management account and the prepayment consumption account for the first user and the second user by utilizing the network ID information of the first user and the second user according to the instruction of the social network platform, and updating and maintaining the information of the prepayment management account and the prepayment consumption account according to the deduction operation of the deduction terminal. The prepayment management system in the embodiment of the present application is deployed at a cloud, is an independent system of a third party, and may provide a safe account platform for the merchant and the consumer user.

The prepayment management account is a management account of the first user for receiving the prepayment of the second user, wherein the prepayment management account may include the prepayment information of a plurality of second users.

The prepayment consumption account includes the prepayment information of the second user in the first user, which may include the account balance and the historical consumption record.

For example, the first user may be a merchant user, and the second user may be a consumer user.

The deduction terminal is used for acquiring the ID verification information provided by the first user to the second user and the payment key of the second user. If the ID verification information is matched with the payment key, then the deduction terminal carries out data interaction with the prepayment management system according to the payment sum set by the first user, communicates with the prepayment management system, and carries out the deduction operation on the second user.

The ID verification information may be provided to the second user respectively through the social network platform or the prepayment management system, and is used for verifying the ID of the second user.

Optionally, the ID verification information may be a two-dimensional code or a bar code. It should be understood that in practical applications, the ID verification information may further be other information that uniquely identifies the information of the consumer user, and will not be limited herein.

The payment key is set by the second user. Optionally, the payment key may be a character string or a biological characteristic. Further, the biological characteristic may be a fingerprint characteristic, a face characteristic or a pupil characteristic. It should be understood that in practical applications, the payment key may include other implementation modes, and will not be limited herein.

For example, the deduction terminal may be a handheld mobile terminal, having the functions of identifying the ID verification information of the consumer user and inputting the characters. Further, if the ID verification information is a two-dimensional code, then the deduction terminal may be a two-dimensional code scanner having key input function.

The prepayment management system in the prepayment system provided by the embodiment of the present application is deployed at a cloud, is an independent system of a third party, and may be bound with the social network platform to directly import the user information in the social network platform. The merchant may conveniently establish a prepayment system in the prepayment management system with a low cost through the social network platform. While the consumer user may query the prepayment information thereof in real time through the social network platform. Moreover, since the account information in the prepayment system is managed by the third party, the consumption safety is more guaranteed.

For easy understanding, the functions of the prepayment system in the embodiment of the present application are described hereinafter, which particularly include the followings.

I. Establish an Initial Account.

The consumer user finds the account of the merchant user in the social network platform, knows preferential treatment activities of prepayment in the social network information of the merchant user, and becomes a prepayment user of the merchant user, then the consumer user may send an account-establishing request to the merchant user through the social network platform, wherein the account-establishing request is used for establishing prepayment account information for the consumer user in the prepayment management account of the merchant user.

The merchant user, after receiving the account-establishing request in the social network platform, provides a verification flow for the consumer user, verifies the ID information of the consumer user. If the ID information is successfully verified, then ID verification information (for example, a two-dimensional code) corresponding to the consumer user is generated and provided to the consumer user.

After acquiring the ID verification information, the consumer user may carry the ID verification information to carry out offline consumption in a physical store of the merchant user.

II. The Consumer User Carries Out Consumption.

The consumer user may store the ID verification information with such mobile terminals as a mobile phone or a tablet computer. After arriving at the physical store of the merchant user, the consumer user needs to show the ID verification information while payment. The merchant user scans the ID verification information with a deduction terminal, and inputs a payment sum on the deduction terminal, so that the deduction terminal generates a payment list of the consumer user according to the payment sum, wherein the payment list includes the ID information of the merchant user. The merchant user may show the payment list to the consumer user. When the consumer user confirms the payment list is correct, the consumer user may input the payment key on the deduction terminal. If the payment key is matched with the ID verification information, then the deduction terminal carries out communication with the prepayment management system according to the payment sum set by the merchant user, to perform a deduction operation on the consumer user. Particularly, the deduction terminal respectively deduct a corresponding sum from the prepayment management account of the merchant user and a corresponding sum from the prepayment consumption account of the consumer user, which are the information maintained by the prepayment management system.

Due to the existence of the ID verification information, the consumer user while consuming, may not carry a physical card. While for the merchant user, the cost for issuing the physical card is also saved.

III. Verify Safety with a Short Message.

In order to avoid others stealing the ID verification information of the consumer user to consume (supposing a stealer may acquire the payment key of the consumer user), the social network platform is instructed to send a short message to the consumer user when the consumer user is consuming and after the merchant user scans the ID verification information with the deduction terminal, wherein the short message is used for requesting the user to return confirmation information of the current ongoing consumption. The consumer user may receive the short message with a mobile phone, and reply the short message to make confirmation. The social network platform or the prepayment management system, after receiving the confirmation information returned by the second user, may authorize the deduction terminal to generate a payment list of the consumer user according to the payment sum.

IV. Carry Out Prepayment Recharging.

The consumer user may send a prepayment recharging request to the merchant user through the social network platform, wherein the prepayment recharging request is used for carrying out a recharging operation on the prepayment management account of the merchant user. The merchant user, after receiving the prepayment recharging request from the social network platform, provides a payment flow for the consumer user according to the prepayment recharging request, so that the consumer user carries out a payment operation according to the payment operation. If the consumer user pays successfully, then information is sent to the prepayment management system so as to respectively update the account balances of the prepayment management account and the prepayment consumption account according to the prepaid sum of the consumer user.

For example, the consumer user may use the micropayment of WeChat to pay in the payment flow. Optionally, the consumer user may further use such payment means as Alipay, Tenpay or E-bank and the like, and will not be limited herein.

IV. Query Prepayment Information.

The consumer user may send an account query request to the merchant user through the social network platform. The merchant user, after receiving the account query request in the social network platform, queries the information of the prepayment consumption account of the consumer user from the prepayment management system according to the account query request, and returns the information of the corresponding prepayment consumption account of the consumer user to the consumer user after acquiring a query result, wherein the information of the prepayment consumption account includes: account balance and historical consumption information.

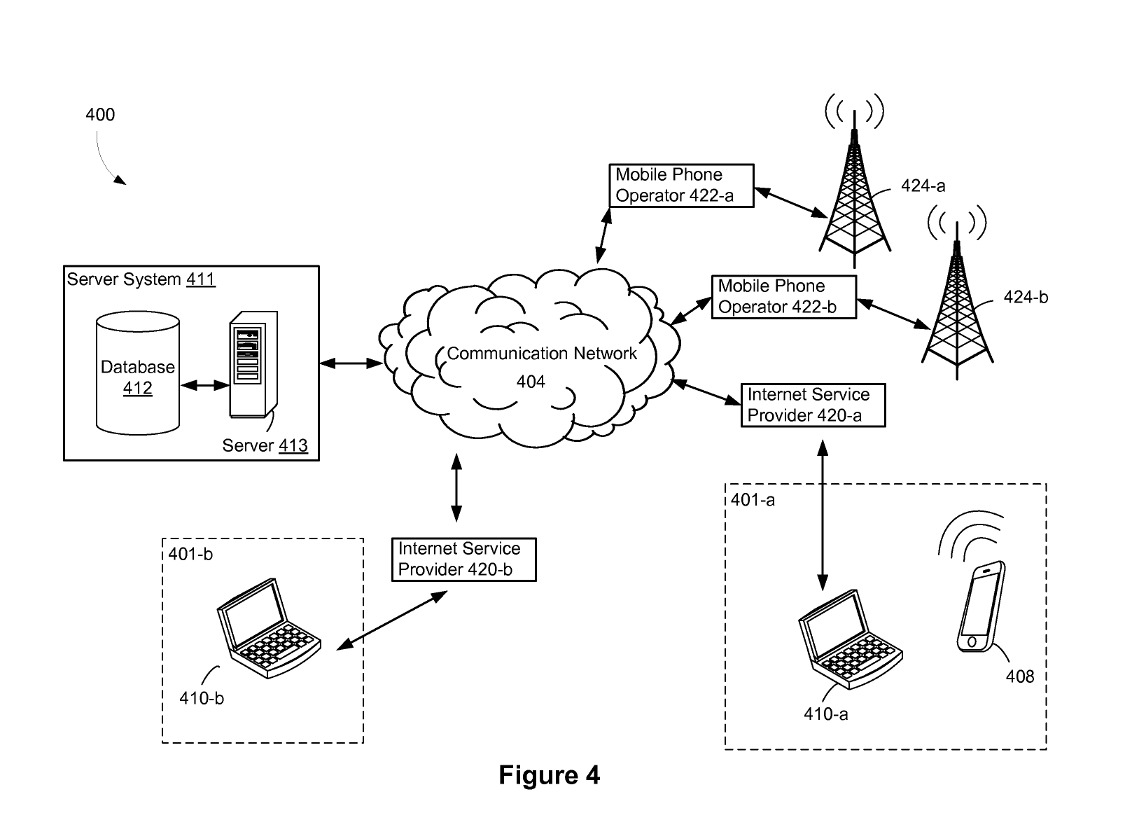

FIG. 4 is a diagram of a client-server environment 400, in accordance with some implementations. The client-server environment 400 includes a server system 411 (e.g., a social networking server system), one or more mobile phone operators 422 (e.g., mobile phone operator 422-a and mobile phone operator 422-b), one or more Internet service providers 420 (e.g., Internet service provider 420-a and Internet service provider 420-b), and communications network 404. Each of the server system 411, the mobile phone operator 422 (i.e. wireless carrier), and the Internet service providers 420 are capable of being connected to the communication network 404 in order to exchange information with one another and/or other devices and systems. Within the server system 411, there is a server computer 413 for receiving and processing data received from mobile client devices 408 and personal/laptop computers 410 (hereinafter “client devices 408/410”). For example, in some circumstances, server system 411 receives a payment request from a first client device (e.g., mobile phone 408) receives transaction requests from a second client device (e.g., personal computer 410-b), processes data included in these requests, and so on.

Within the server system 411, there is also a database 412 for storing information (e.g., user prepayment account information corresponding to users of respective client devices 408/410, information corresponding to payment requests, unique identifiers corresponding to payment requests, payment keys for various users, and the like). Additionally, the mobile phone operator 422 and the Internet service provider 420 are operable to connect client devices 408/410 to the communication network 404 as well. For example, a smart phone 408 is operable with the network of the mobile phone operator 422-a, which includes for example, a base station 424-a. Similarly, for example, a first user's laptop computer 410-a (or tablet, desktop, workstation or the like) is connectable to the network provided by a first Internet service provider 420-a, which is ultimately connectable to the communication network 404. A second user's laptop computer 410-b (or tablet, desktop, workstation or the like) is connectable to the network provided by a second Internet service provider 420-b, which is ultimately connectable to the communication network 404.

When a respective client device 408/410 is connected to network 404, and thereby connected to server system 411, the respective client device 408/410 is said to be in an “online state.” Conversely, when a respective client device 408/410 is not connected to network 404, and thereby not connected to server system 411, the respective client device 408/410 is said to be in an “offline state.” The embodiments described herein can be used to securely transfer funds between an account of the first user and an account of the second user, variously, when the first user is in an online state or an offline state.

The communication network 404 may be any combination of wired and wireless local area network (LAN) and/or wide area network (WAN), such as an intranet, an extranet, including a portion of the Internet. It is sufficient that the communication network 404 provides communication capability between client devices and servers. In some implementations, the communication network 404 uses the HyperText Transport Protocol (HTTP) to transport information using the Transmission Control Protocol/Internet Protocol (TCP/IP). HTTP permits a client device to access various resources available via the communication network 404. However, the various implementations described herein are not limited to the use of any particular protocol.

Moreover, those skilled in the art will appreciate from the present application that any number of such devices and/or systems may be provided in a client-server environment, and particular devices may be altogether absent. In other words, the client-server environment 400 is merely an example provided to discuss more pertinent features of the present application.

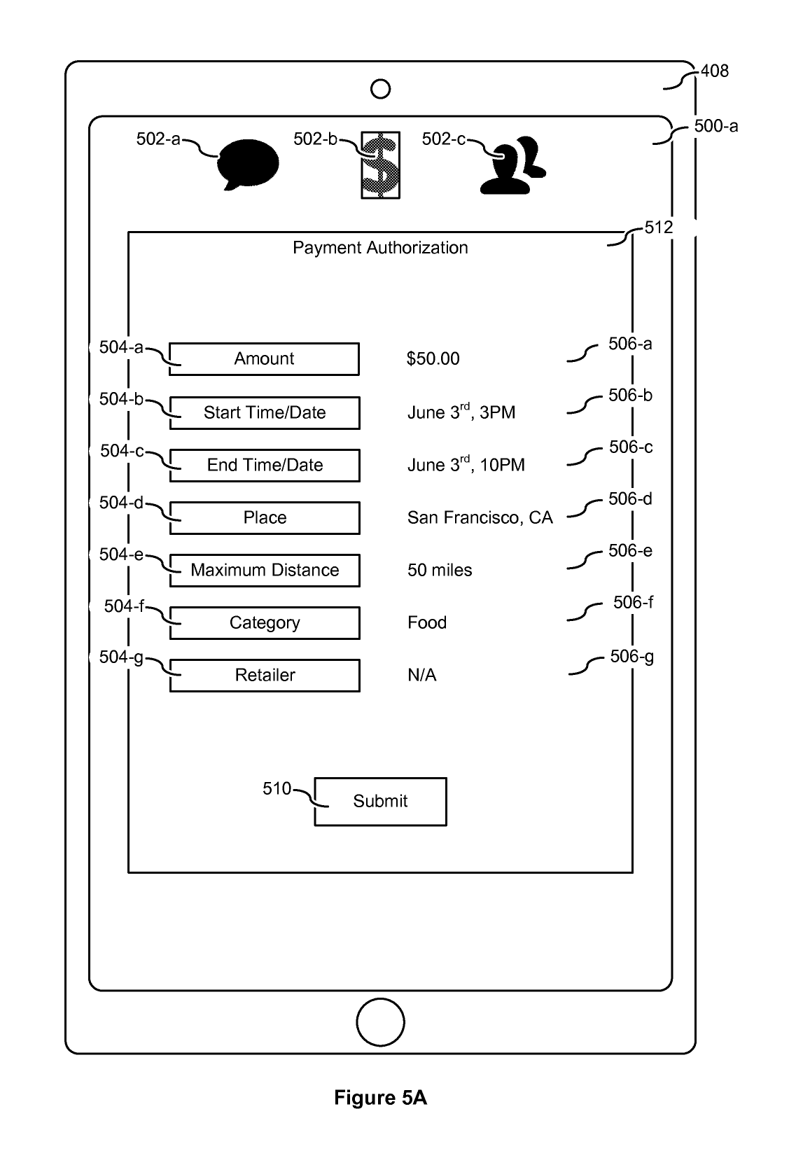

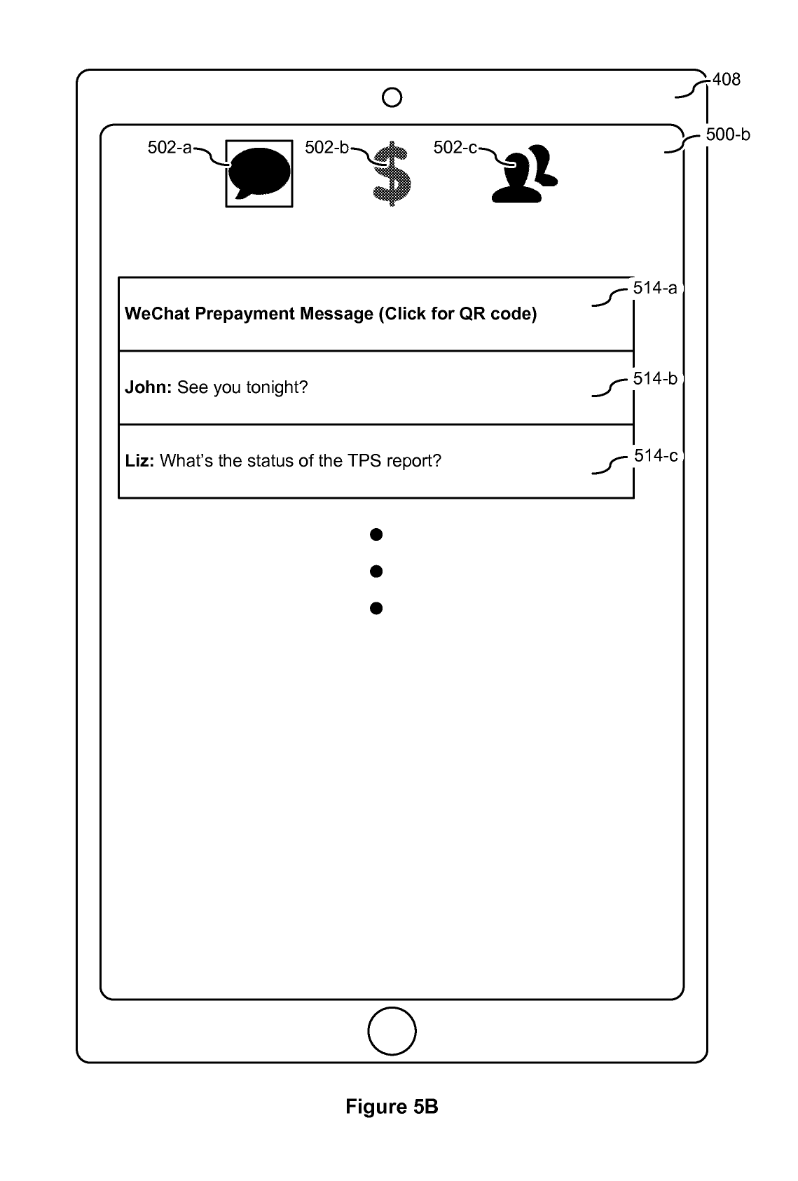

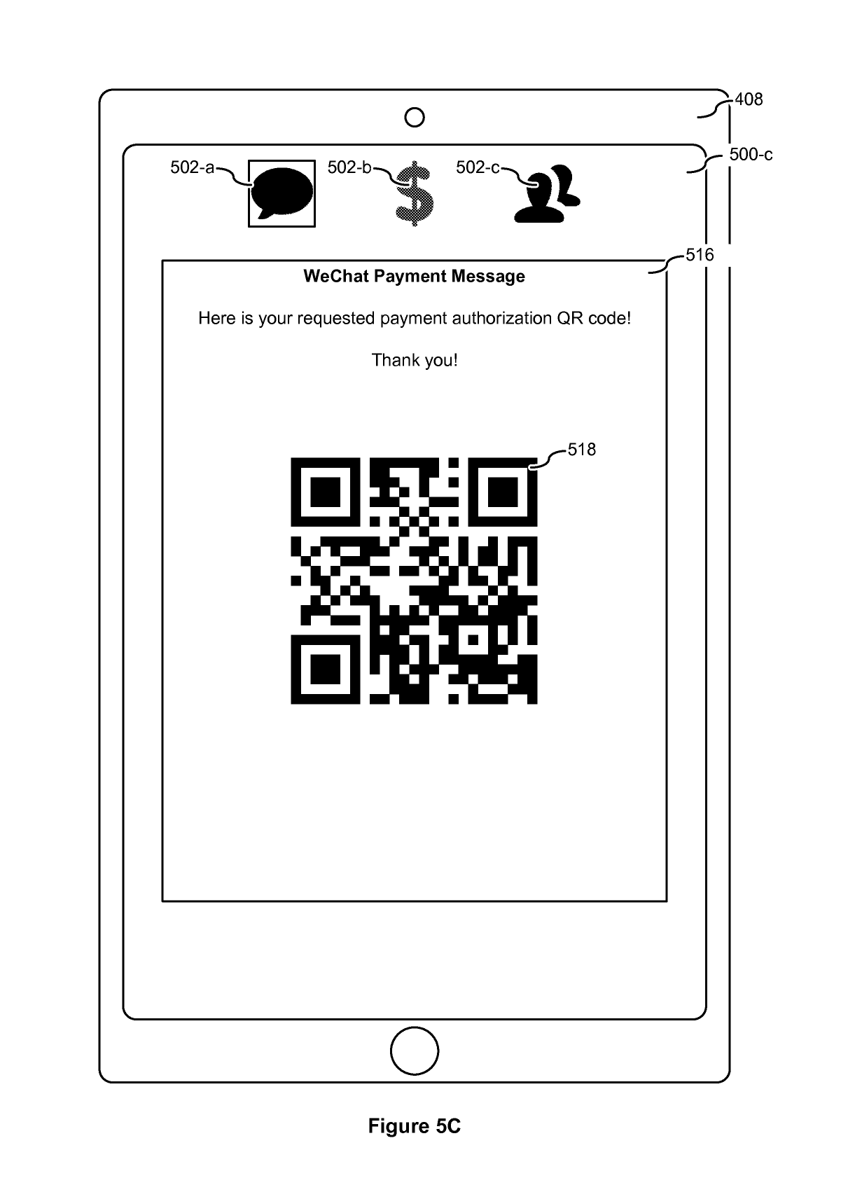

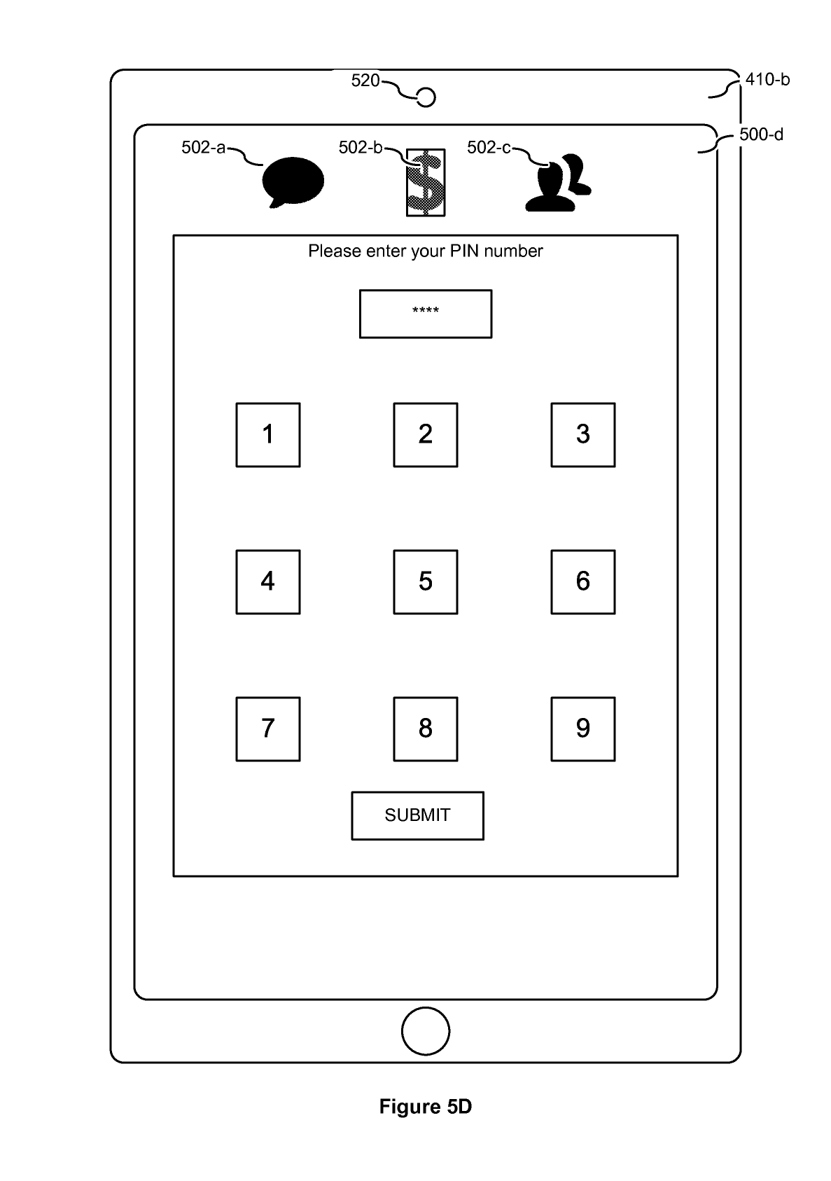

FIGS. 5A-5D illustrate an example user interface 500 for making secure payments, in accordance with some embodiments. In some embodiments, user interface 500 is displayed on device 408 as a component of a social networking mobile application (“app”). For example, WeChat, Facebook, and Twitter all provide mobile applications through which at least some of their services are available. Individual pages, or screens, that comprise user interface 500 are denoted with an additional letter. For example, user interface page 500-a (FIG. 5A) is a user interface screen that may be viewed by a user of device 408 at a particular time. The user interface 500 also includes several tabs 502 that, in some embodiments, correspond to particular services offered the social networking service. For example, tab 502-a is a chat tab through which a user can chat with friends and/or exchange messages with the social networking service; tab 502-b is an online payment tab through which a user can manage financial transaction services (e.g. prepayment accounts) that are offer by the social networking service; and tab 502-c is a friends/feed tab through which a user can view his or her friends' activities (e.g., posts) and/or search and add friends.

Device 408 is assumed to be a consumer's device for the sake of furthering the explanation of this example. In FIG. 5A, online payment tab 502-b is selected, causing user interface page 500-a to include region 512 for making a payment request. In some embodiments, region 512 is navigated to within tab 502-b, or, stated another way, additional user inputs are required to cause device 408 to display region 512.

In some embodiments, the payment request corresponds to a request to set money aside (e.g., designate, or “preload,” funds) for later transactions. This is advantageous for several reasons. Among them is that fact that, because the payment request is made ahead of time, the social networking service can retrieve the money from the user's bank account and the risk of defaulting on credit is mitigated. The user enters parameter values 506 for some or all of the various payment request parameters 504. For example, the user enters amount value 506-a of $50.00 (a parameter value) corresponding to amount parameter 504-a. The payment request is sent (e.g., transmitted) to the social network service when the user activates the affordance 510 (e.g., by using a touch input when the display is a touch screen). In response, the social networking service generates and sends unique identifier 518 (FIG. 5C) so that it can be used, as explained further below, to make purchases against the balance of the payment request.

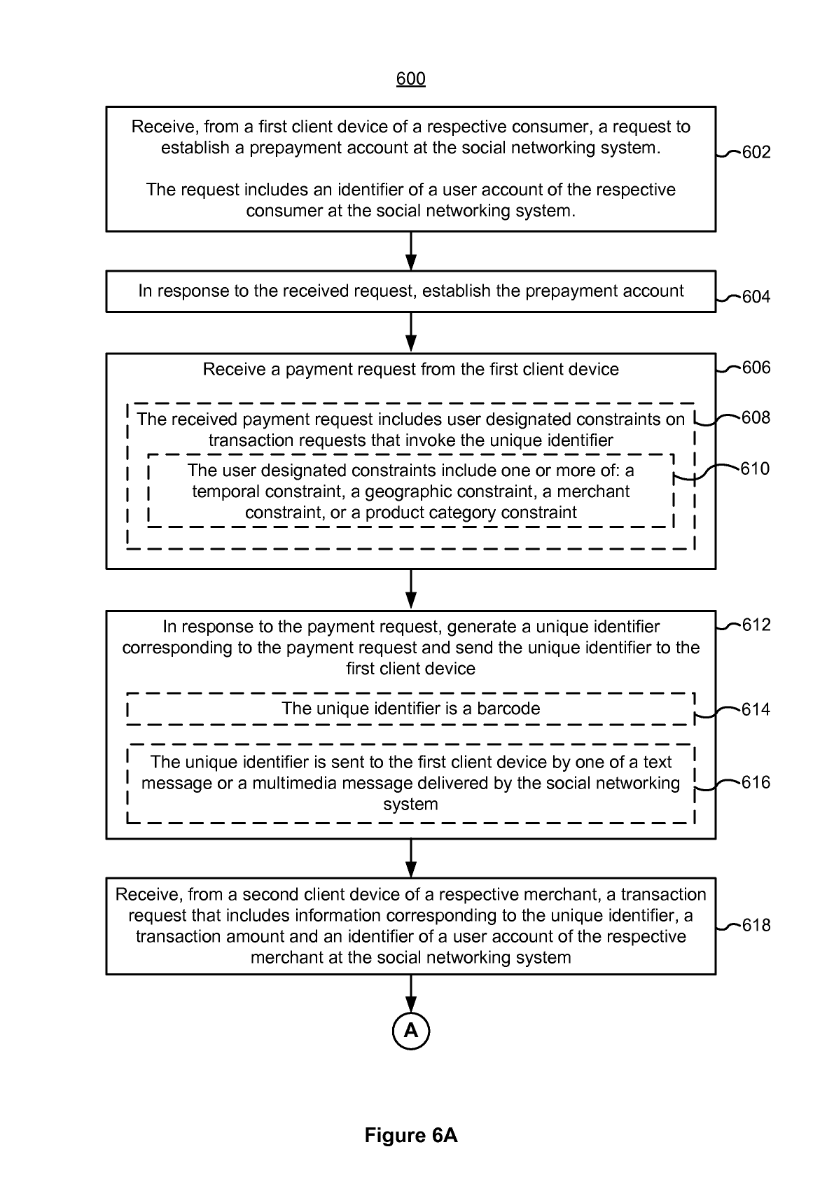

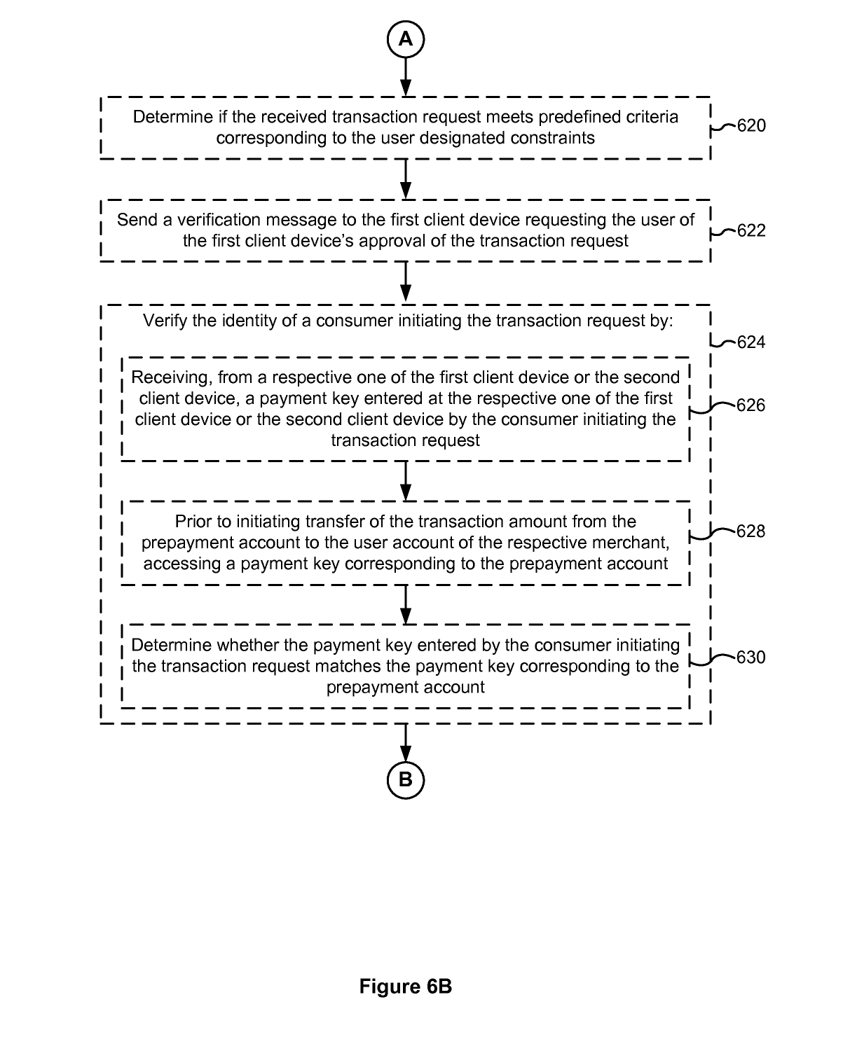

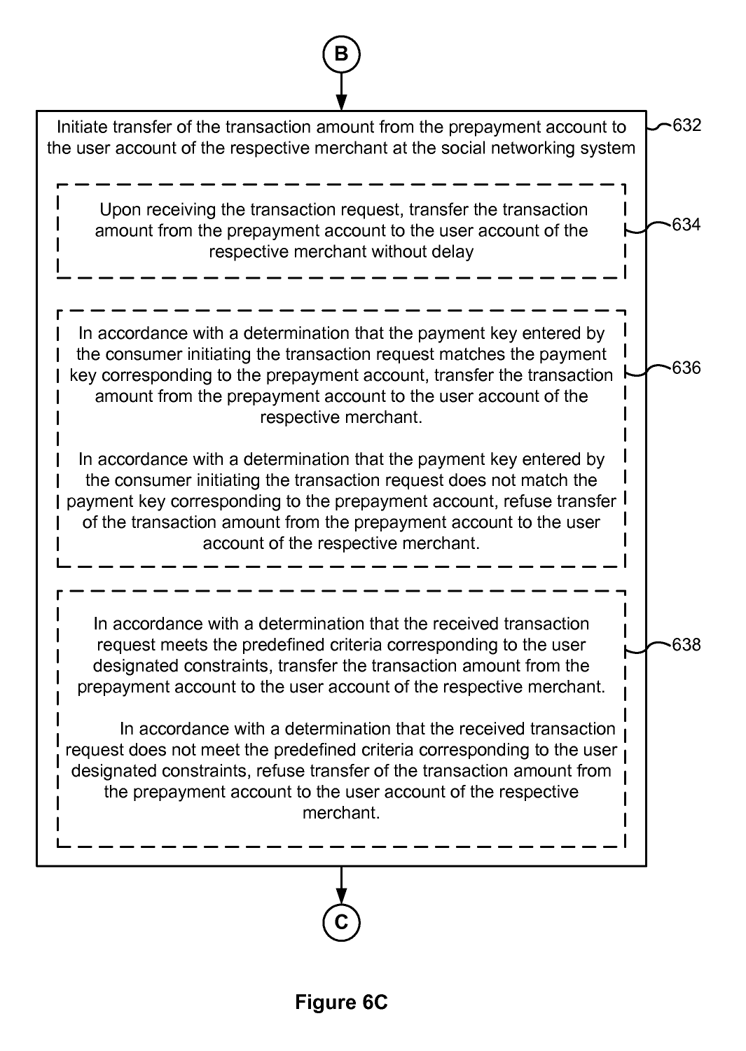

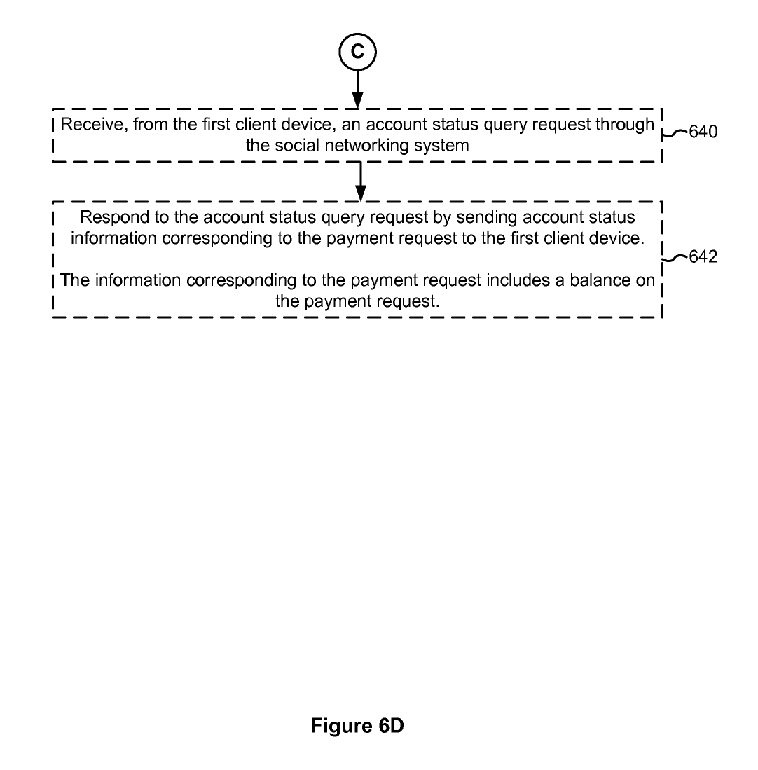

In some embodiments, some of the parameters 504 are user designated constraints on transaction requests that invoke unique identifier 518 (FIG. 5C). In some embodiments, the user designated constraints include temporal constraints such as start time/date parameter 504-b (for which the user enters start time/date value 506-b) and an end time/date parameter 504-c (for which the user enters end time/date value 506-c). In some embodiments, the user designated constraints include geographic constraints such as place (e.g., location) parameter 504-d (for which the user enters place value 506-d) and maximum distance (e.g., radius) parameter 504-e (for which the user enters maximum distance value 506-e). Maximum distance value 506-e sets a maximum distance from the location given by place value 506-d for which unique identifier 518 (FIG. 5C) can be used. In some embodiments, the user designated constraints include product constraints such as category parameter 504-f (for which the user enters category value 506-f, such as “food”; “shoes”; or “electronics.”) and/or retailer parameter 504-g (for which the user enters retailer value 506-g, such as a specific retailer). Further details concerning these types of constraints and the manner in which these constraints are used a provided with reference to method 600 (FIGS. 6A-6D). In some embodiments, when a user does not enter a respective parameter value 506 corresponding to a respective parameter 504 (e.g., as is the case with retailer parameter 504-g), unique identifier 518 (FIG. 5C) can be used in an unconstrained manner with regard to the respective parameter (e.g., unique identifier 518, FIG. 5C, can be used for any retailer).

The payment request is sent to a social networking server system (e.g., server system 411, FIG. 4) executing the social networking service. The social networking server system generates unique identifier 518 (FIG. 5C) and, in some embodiments, sends unique identifier 518 (FIG. 5C) to client device 408 by a text message or multimedia message using the social networking service. For example, as shown in FIG. 5B, chat tab 502-a is selected, bringing up user interface page 500-b, which shows a listing of headers of the user's social media service messages. Message header 514-a is an unopened WeChat Prepayment message indicating that the user should click to open the message and view a QR code corresponding to the payment request (in this example, the QR code is unique identifier 518). Further, in this example, message header 514-a is mixed in with (e.g., displayed together with) the user's other message headers 514-b and 514-c (e.g., correspond to messages from the user's friends). This is advantageous because users are often accustomed to navigating to their messages, and thus will be able to conveniently navigate to their QR payment codes (e.g., unique identifiers) as well.

As shown in FIG. 5C, when the user opens message 514-a, the device 508 displays user interface page 500-c that includes region 516 displaying message 518, which corresponds to message header 514-a in FIG. 5B. The message includes unique identifier 518. As shown in this example, in some embodiments, unique identifier 518 is a one- or two-dimensional barcode (e.g., a QR code).

FIG. 5D illustrates user interface page 500-d on device 410-b, which is a different device than device 408. Device 410-b is a merchant's device. Although one user is considered the consumer in a transaction and the other is considered a merchant in the transaction, the consumer and merchant may both be using the same mobile application on their respective devices. That is to say, in some embodiments, the social networking service allows users to be either merchants or consumers, depending on the context (e.g., whether a user has something she wants to sell, or has something she wants to buy). It is assumed in FIG. 5D that device 410-b has “captured” unique identifier 518 by photographing unique identifier 518 with camera 520. Capturing unique identifier 518 (embodied as a QR code) via a camera is, however, just an example. Other manners through which unique identifier 518 may be exchanged, and other embodiments of unique identifier 518, will be apparent to those skilled in the art.

In any event, after capturing unique identifier 518 the merchant's device 410-b prompts the consumer to enter a payment key, for example, using a keypad. By having the consumer enter a payment key (e.g., a PIN number) on the merchant's device 410-b, the transaction 408 can (1) transpire while the consumer is in an offline mode while, (2) mitigating the risk that the consumer's QR code could be commandeered by an unintended person. The PIN number is optionally sent by the merchant's device 410-b along with the rest of a transaction request, as described with reference to method 600 (FIGS. 6A-6D) to verify the transaction.

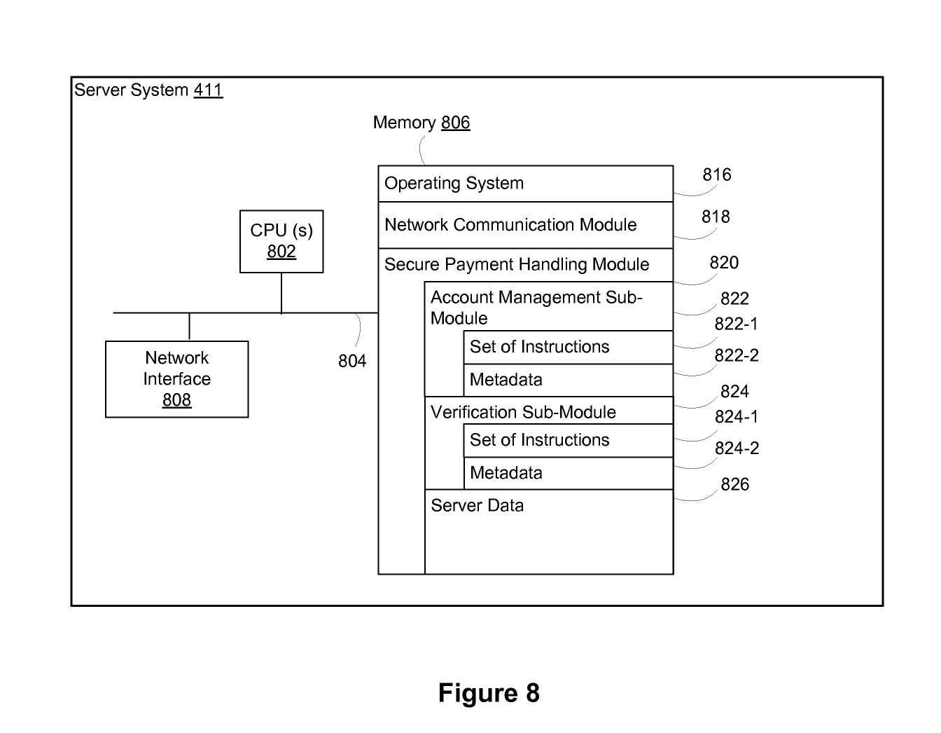

FIGS. 6A-6D include a flow chart of method 600 of handling a secure payment over a network, in accordance with some implementations. In some implementations, one or more operations in method 600 are performed at a social network server system (e.g., server system 411, as described with reference to FIG. 4 and/or FIG. 8). For ease of explanation, the entirety of method 600 is described as being performed by a social networking system.

The social networking system receives (602), from a first client device of a respective consumer, a request to establish a prepayment account at the social networking system. In some embodiments, the request is a request for an account with the social networking system (e.g., the request is to register the consumer with the social networking system). Alternatively, in some circumstances, the consumer is already registered with the social networking system and the request is a request to add financial services including establishment of a prepayment account to the consumer's social networking system account. The request includes an identifier of a user account of the respective consumer (e.g., an email address, a log-in name, a hashed value of an email address) at the social networking system. In some embodiments, the request also includes financial information such as the consumer's credit card number, bank account number, and/or other information that can be used to obtain funds from the consumer. In some embodiments, the request also includes a payment key (e.g., a PIN number) that the user designates while formulating the request.

In response to the received request, the social networking server system establishes (604) the prepayment account. For example, in some embodiments, the social networking server system stores information including the identifier of the user account, the consumer's credit card number, the consumer's bank account number, and the like, in database 412 (FIG. 4).

The server system receives (606) a payment request from the first client device (e.g., a request sent from user interface page 500-a, FIG. 5A). In some embodiments, the payment request is a request to preload funds for future transaction requests. To that end, in some embodiments, the social networking system deducts the funds using the consumer's financial information (e.g., credit card number, bank account number) in response to the request. For example, the consumer may be aware the she is going shopping that evening and may want to preload funds for the shopping excursion. The consumer may want to do this for any number of reasons. For example, the consumer may not be able to obtain a credit card based on her credit history and thus may wish to preload funds before shopping. In some circumstances, the consumer may be a child or adolescent whose expenditure is controlled by his parents. In such a circumstance, the parents can preload funds for their child's shopping excursion to ensure that the child does not exceed his allowance. Alternatively, the consumer may wish to ensure that she does not exceed her own budget. To that end, in some embodiments, the social networking system is a financial planning system. Many other reasons exist for preloading funds in accordance with method 600.

One additional reason, however, is that the preloaded funds can be made more secure, meaning that there is less risk of losing the funds, as compared to the risk presented by carrying cash or a credit card. As explained below, transactions are made in accordance with a unique identifier corresponding to the payment request. As an example of a feature of method 600 that enhances such security, in some embodiments, the received payment request includes (608) user designated constraints on transaction requests that invoke the unique identifier (e.g., which are entered as parameter/parameter-value pairs, as shown in FIG. 5A). In various embodiments, the user designated constraints include (610) one or more of: a temporal constraint, a geographic constraint, a merchant constraint, or a product category constraint, or a combination thereof.

Examples of temporal constraints include the start time/date parameter 504-b and end time/date 504-c (FIG. 5A). A temporal constraint places restrictions on one or more time ranges for which the unique identifier can be invoked in a transaction request. For example, as shown in FIG. 5A, because start time/date parameter 504-b has a start time/date parameter value 506-b of “June 3rd, 3 PM,” the unique identifier can be used to invoke a transaction request on or after June 3rd (e.g., of the current year) at 3:00 PM. Similarly because end time/date parameter 504-b has an end time/date parameter value 506-b of “June 3rd, 10 PM,” the unique identifier can be used to invoke a transaction request on or before June 3rd (e.g., of the current year) at 10:00 PM. Combined, these temporal restraints restrict the unique identifier to invoking transaction requests in a time window of June 3rd from 3:00 PM to 10:00 PM.

Examples of geographic constraints include a name of a town, county, city, state, country, landmark (e.g., a shopping mall or a flea market), precise location (e.g., latitude/longitude coordinates, an address, or cross-streets), and/or a distance from any of the aforementioned. When a transaction request is received from outside of the town, county, city, state, country, landmark, location, and/or outside of the specified distance therefrom, the transaction request is denied (e.g., refused).

Examples of merchant constraints include specific retailers at which the payment request can be used (e.g., the unique identifier invoked). For example, a merchant constraint may require that a transaction request originate at a Starbucks (e.g., Starbucks is the merchant), otherwise the transaction request is denied (e.g., refused). Product category restraints, in some circumstances, restrict the funds to be used on food, electronics, clothing, etc.

In response to the payment request, the social networking system generates (612) a unique identifier corresponding to the payment request and sends the unique identifier to the first client device. The social networking system also optionally stores information corresponding to the unique identifier, or stores the unique identifier itself, in database 412 (FIG. 4). In some embodiments, the unique identifier is (614) a barcode (e.g., a one- or two-dimensional barcode such as unique identifier 518, FIG. 5C). In some embodiments, the unique identifier is generated using a hashed version of information provided in the payment request. In some embodiments, the unique identifier is sent (616) to the first client device by one of a text message or a multimedia message delivered by the social networking system (e.g., as shown with reference to FIG. 5B).

The social networking system receives (618), from a second client device of a respective merchant, a transaction request that includes information corresponding to the unique identifier, a transaction amount, and an identifier of a user account of the respective merchant at the social networking system (e.g., his or her email address). For example, a consumer—aware of her plans to go shopping that evening—may have preloaded funds in accordance with operations 606-610 described above. During the shopping excursion, for example, the consumer decides to buy a pair of shoes. To pay for the pair of shoes, the consumer opens the social networking service's application on her mobile phone and shows the QR code, which is contained in a message from the social networking service, to the merchant. The merchant then captures the QR code, and enters the transaction amount (e.g., the cost of the shoes) and sends it to the social networking system. In some embodiments, the identifier of the user account of the respective merchant is automatically appended to the request by virtue of the fact that the request is coming from the merchant's account.

Although one user is considered the consumer in a transaction and the other is considered a merchant in the transaction, the consumer and merchant may both be using the same mobile application on their respective devices. To that end, in some circumstances, each of the consumer's client device and the merchant's client device is a portable multifunction device (e.g., a smart-phone, tablet, or the like, with standard cellular hardware). Alternatively, in some embodiments, the merchant's client device is a cash register, kiosk, or terminal, and optionally has special hardware (e.g., a fingerprint scanner).

Operations 620-630, described below, are various manners through which security of method 600 is optionally enhanced.

For example, in some embodiments, the social networking system determines (620) if the received transaction request meets predefined criteria corresponding to the user designated constraints. In some embodiments, the predefined criteria include that the transaction request is within all of the specified parameter values for a plurality of parameters designated during the payment request (e.g., parameters 504-b through 504-g corresponding respectively to parameter values 506-b through 506-g, FIG. 5A). In some embodiments, the predefined criteria include a criterion that a sufficient balance is present on the payment request (e.g., enough of the preloaded funds remain).

In some embodiments, the social networking service sends (622) a verification message to the first client device requesting the user of the first client device's approval of the transaction request. In some embodiments, the verification message is a window that pops-up on the user interface of the social networking service's mobile application that states, for example, “John's Shoe store is attempting to charge you $43.29” and presents affordances corresponding to “Approve” and “Deny.” In some embodiments, the verification message is a text message or multimedia message delivered through social media service that displays a similar message (e.g., “John's Shoe store is attempting to charge you $43.29”) and asks the consumer to reply with “Yes” if he wishes to approve the transaction and “No” if he wishes to deny the transaction.

In some embodiments, the social networking service verifies (624) the identity of a consumer initiating the transaction request. In various embodiments, this is done by receiving (626), from a respective one of the first client device or the second client device, a payment key (e.g., a PIN number) entered at the respective one of the first client device or the second client device (e.g., using user interface page 500-c, FIG. 5C) by the consumer initiating the transaction request. In some embodiments, the payment key is a picture of the consumer and the social networking service uses computer-implemented facial recognition to verify the identity of the consumer. These embodiments have the added benefit of reducing plausible deniability should the consumer later contest the charges to the social networking service. In some embodiments, the merchant's client device includes a fingerprint scanner and the payment key is a scan of one of the consumer's fingerprints (e.g., the consumer's left index finger).

In any event, prior to initiating transfer of the transaction amount from the prepayment account to the user account of the respective merchant, the social networking service accesses (628) a payment key corresponding to the prepayment account (e.g., from database 412, FIG. 4). The social networking service determines (630) whether the payment key entered by the consumer initiating the transaction request matches the payment key corresponding to the prepayment account. For example, the social networking service determines whether the initiating consumer's entered PIN, photograph, or fingerprint scan matches the recorded PIN, photograph, or fingerprint scan, respectively, for the user whose account the initiating consumer is trying to draw from.

Operations 632-638, described below, provide manners in which funds are transferred from the consumer to the merchant, thus completing the transaction. Some of the embodiments described below allow the transaction to proceed (e.g., funds to be transferred) only when certain security criteria are met, for example, with regards to the payment key and user designated constraints described above.

The social networking service initiates (632) transfer of the transaction amount from the prepayment account to the user account of the respective merchant at the social networking system. For example, in embodiments in which the social networking service deducts the funds from the consumers account upon receipt of the payment request (operation 606), the social networking service is already in possession of the preloaded funds and accordingly debits the transaction amount from the balance of the consumer's payment request to reflect the transaction. The social networking service also correspondingly credits the merchant's account with the transaction amount. In some embodiments, the social networking service retains a percentage of the transaction amount as a transaction fee.

In some embodiments, initiating transfer of the transaction amount from the prepayment account to the user account of the respective merchant at the social networking system includes (634), upon receiving the transaction request, transferring the transaction amount from the prepayment account to the user account of the respective merchant without delay.

Alternatively, in some embodiments (e.g., those embodiment which utilize a payment key as described with reference to operations 626-630), in accordance with a determination that the payment key entered by the consumer initiating the transaction request matches the payment key corresponding to the prepayment account, the social networking service transfers (636) the transaction amount from the prepayment account to the user account of the respective merchant. But in accordance with a determination that the payment key entered by the consumer initiating the transaction request does not match the payment key corresponding to the prepayment account, the social networking service refuses transfer of the transaction amount from the prepayment account to the user account of the respective merchant.

In a similar manner, in some embodiments, in accordance with a determination that the received transaction request meets the predefined criteria corresponding to the user designated constraints, the social networking service transfers (638) the transaction amount from the prepayment account to the user account of the respective merchant. But in accordance with a determination that the received transaction request does not meet the predefined criteria corresponding to the user designated constraints, the social networking service refuses transfer of the transaction amount from the prepayment account to the user account of the respective merchant.

It should be understood that the criteria employed in operations 636 and 638 may be used in combination, for example, using a logical “AND.” Stated another way, in some embodiments, the social networking service transfers the transaction amount from the prepayment account to the user account of the respective merchant in accordance with both a determination that the received transaction request meets the predefined criteria corresponding to the user designated constraints and a determination that the payment key entered by the consumer initiating the transaction request matches the payment key corresponding to the prepayment account. When either criterion is determined not to be true, in some embodiments, the social networking service refuses (e.g., denies) the transfer.

Operations 640 and 642, described below, provide convenient manners through which a consumer can check information pertaining to his or her payment request (e.g., the consumer can obtain a balance on the payment request).

In some embodiments, the social networking service receives (640), from the first client device, an account status query request through the social networking system. In some embodiments, the account status query request is received in the form of a text message or multimedia message delivered over the social networking system. For example, the social networking system may provide instructions with their mobile application that instruct users to text “account status” (or another predefined string) over the social network service for account status information. Alternatively, in some embodiments, social networking service's mobile application include a user interface page (see description of FIGS. 5A-5D) through which a user can view account status information. When a user (e.g., a consumer) navigates to the user interface page for account status information, the mobile application automatically sends the account status query request to the social networking service so that the user may view up-to-date account status information. Still alternatively, in some embodiments, the consumer transfers his or her unique identifier (e.g., by scanning his or her QR code) at a merchant's client device (e.g., a cash register, kiosk, or terminal), and enters an affordance for an account status query. Thus, in some embodiments, rather than receiving the account status query from the first client device, in some embodiments, the social networking system receives the account status query from a merchant's client device.

In some embodiments, the social networking system responds (642) to the account status query request by sending account status information corresponding to the payment request to the first client device. The information corresponding to the payment request includes a balance on the payment request. In some embodiments, the account status information is delivered by text message or multimedia message by the social networking system to the consumer's client device (e.g., in an analogous fashion to the delivery of unique identifier 518 described with reference to FIGS. 5B-5C).

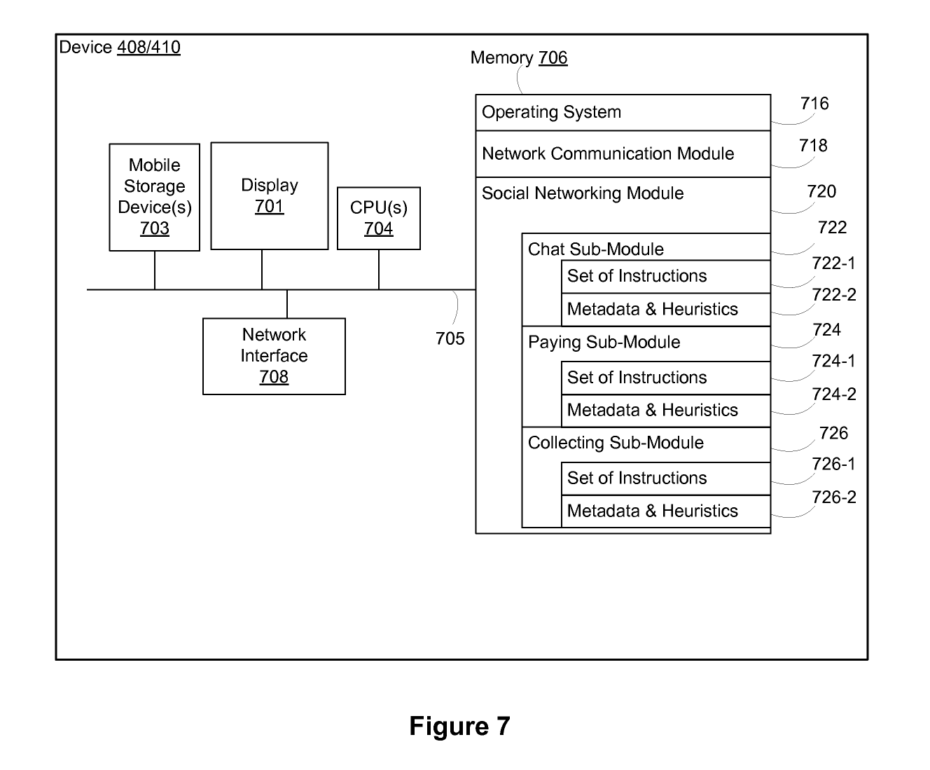

FIG. 7 is a diagram of an example implementation of a client device 408/410 for transferring funds (e.g., paying funds or collecting funds), in accordance with some implementations. While certain specific features are illustrated, those skilled in the art will appreciate from the present disclosure that various other features have not been illustrated for the sake of brevity and so as not to obscure more pertinent aspects of the implementations disclosed herein.

To that end, the device 408/410 includes one or more processing units (CPUs) 704, one or more network or other communications interfaces 708, display 701, memory 706, one or more mobile storage devices 703, and one or more communication buses 705 for interconnecting these and various other components. The communication buses 705 may include circuitry (sometimes called a chipset) that interconnects and controls communications between system components. Memory 706 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 706 may optionally include one or more storage devices remotely located from the CPUs 704. Memory 706, including the non-volatile and volatile memory devices within memory 706, comprises a non-transitory computer readable storage medium.

In some implementations, memory 706 or the non-transitory computer readable storage medium of memory 706 stores the following programs, modules and data structures, or a subset thereof including an operating system 716, a network communication module 718, and a social networking module 720 (e.g., a mobile application for a social networking system).

The operating system 716 includes procedures for handling various basic system services and for performing hardware dependent tasks.

The network communication module 718 facilitates communication with other devices via the one or more communication network interfaces 708 (wired or wireless) and one or more communication networks, such as the Internet, other wide area networks, local area networks, metropolitan area networks, and so on.

In some implementations, social networking module 720 includes chat sub-module 722 for communicating with friends via text messages and/or multimedia messages, as well as receiving and optionally sending text message and/or multimedia messages to a social networking service (e.g., implemented on server system 411, FIG. 4). Such communications can include, for example, requests to establish a prepayment account; payment requests; and/or transaction requests. To this end, chat sub-module 722 includes a set of instructions 722-1 and, optionally, metadata 722-2. In some implementations, secure payment module 720 also includes a paying sub-module 724 (e.g., for displaying user interface page 500-a, FIG. 5D) having a set of instructions 724-1 and, optionally, metadata 724-2, as well as a collecting sub-module 726 (e.g., for displaying user interface page 500-d, FIG. 5D and/or scanning, capturing, photographing, or otherwise obtaining another users payment request unique identifier) having a set of instructions 726-1 and, optionally, metadata 726-2.

FIG. 8 is a block diagram illustrating a server system 411, discussed above with reference to FIG. 4, in accordance with some implementations. While certain specific features are illustrated, those skilled in the art will appreciate from the present disclosure that various other features have not been illustrated for the sake of brevity and so as not to obscure more pertinent aspects of the implementations disclosed herein.

To that end, server system 411 includes one or more processing units (CPUs) 802, one or more network or other communications interfaces 808, memory 806, and one or more communication buses 804 for interconnecting these and various other components. The communication buses 804 may include circuitry (sometimes called a chipset) that interconnects and controls communications between system components. Memory 806 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 806 may optionally include one or more storage devices remotely located from the CPUs 802. Memory 806, including the non-volatile and volatile memory devices within memory 806, comprises a non-transitory computer readable storage medium.

In some implementations, memory 806 or the non-transitory computer readable storage medium of memory 806 stores the following programs, modules and data structures, or a subset thereof including an operating system 816, a network communication module 818, a secure payment handling module 820.

The operating system 816 includes procedures for handling various basic system services and for performing hardware dependent tasks.

The network communication module 818 facilitates communication with other devices (e.g., client devices 1508/1510) via the one or more communication network interfaces 808 (wired or wireless) and one or more communication networks, such as the Internet, other wide area networks, local area networks, metropolitan area networks, and so on.

The secure payment handling module 820 is configured to manage consumer's and merchant's account (e.g., with account management sub-module 822, which includes a set of instructions 822-1 and optionally metadata 822-2). Management of consumer's and merchant's account includes, in some embodiments, processing requests to establish prepayment accounts, payment requests, and transaction requests. The latter optionally includes transferring funds from a consumer to a merchant. The secure payment handling module 820 also optionally includes a verification sub-module which performs various verification tasks described with reference to method 600, operations 620-630 (FIGS. 6A-6D). Various data that is received or generated (e.g., optionally including consumers' financial data, account data, unique identifiers for payment requests, PIN numbers, fingerprints, photographs) is stored in server data 826, which is optionally embodied as database 412 (FIG. 4).

A person of ordinary skill in the art can understand that all or a part of the steps of the methods according to the foregoing embodiments may be implemented by a program instructing relevant hardware. The program may be stored in a computer readable storage medium, and the storage medium may include a flash memory, a Read-Only Memory (ROM), a Random Access Memory (RAM), a magnetic disk, or an optical disc.

While particular embodiments are described above, it will be understood it is not intended to limit the disclosure to these particular embodiments. On the contrary, the disclosure includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although the terms first, second, etc. may be used herein to describe various elements, these elements should not be limited by these terms. These terms are only used to distinguish one element from another. For example, first criteria could be termed second criteria, and, similarly, second criteria could be termed first criteria, without departing from the scope of the present disclosure. First criteria and second criteria are both criteria, but they are not the same criteria.

The terminology used in the description of the disclosure herein is for the purpose of describing particular embodiments only and is not intended to be limiting of the disclosure. As used in the description of the disclosure and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the disclosure to the precise forms disclosed. Many modifications and variations are possible in view of the above teachings. The implementations were chosen and described in order to best explain principles of the disclosure and its practical applications, to thereby enable others skilled in the art to best utilize the disclosure and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A method comprising:
at a social networking system:
receiving, from a first client device of a respective consumer, a request to establish a prepayment account at the social networking system, wherein the request includes an identifier of a user account of the respective consumer at the social networking system;
in response to the received request, establishing the prepayment account;
receiving a payment request from the first client device;
in response to the payment request, generating a unique identifier corresponding to the payment request and sending the unique identifier to the first client device;
receiving, from a second client device of a respective merchant, a transaction request that includes information corresponding to the unique identifier, a transaction amount, and an identifier of a user account of the respective merchant at the social networking system; and
initiating transfer of the transaction amount from the prepayment account to the user account of the respective merchant at the social networking system.

2. The method of claim 1, wherein the unique identifier is a barcode.

3. The method of claim 1, wherein the unique identifier is sent to the first client device by one of a text message or a multimedia message delivered by the social networking system.

4. The method of claim 1, further including, sending a verification message to the first client device requesting the user of the first client device's approval of the transaction request.

5. The method of claim 1, further including verifying the identity of a consumer initiating the transaction request by:
receiving, from a respective one of the first client device or the second client device, a payment key entered at the respective one of the first client device or the second client device by the consumer initiating the transaction request;
prior to initiating transfer of the transaction amount from the prepayment account to the user account of the respective merchant, accessing a payment key corresponding to the prepayment account;
determining whether the payment key entered by the consumer initiating the transaction request matches the payment key corresponding to the prepayment account;
wherein initiating transfer of the transaction amount from the prepayment account to the user account of the respective merchant at the social networking system includes:
in accordance with a determination that the payment key entered by the consumer initiating the transaction request matches the payment key corresponding to the prepayment account, transferring the transaction amount from the prepayment account to the user account of the respective merchant; and
in accordance with a determination that the payment key entered by the consumer initiating the transaction request does not match the payment key corresponding to the prepayment account, refusing transfer of the transaction amount from the prepayment account to the user account of the respective merchant.

6. The method of claim 1, wherein the received payment request includes user designated constraints on transaction requests that invoke the unique identifier; and
the method further includes determining if the received transaction request meets predefined criteria corresponding to the user designated constraints;
wherein initiating transfer of the transaction amount from the prepayment account to the user account of the respective merchant at the social networking system includes:
in accordance with a determination that the received transaction request meets the predefined criteria corresponding to the user designated constraints, transferring the transaction amount from the prepayment account to the user account of the respective merchant; and
in accordance with a determination that the received transaction request does not meet the predefined criteria corresponding to the user designated constraints, refusing transfer of the transaction amount from the prepayment account to the user account of the respective merchant.

7. The method of claim 6, wherein the user designated constraints include one or more of: a temporal constraint, a geographic constraint, a merchant constraint, or a product category constraint.

8. The method of claim 1, wherein initiating transfer of the transaction amount from the prepayment account to the user account of the respective merchant at the social networking system includes, upon receiving the transaction request, transferring the transaction amount from the prepayment account to the user account of the respective merchant without delay.

9. The method of claim 1, further comprising:
receiving, from the first client device, an account status query request through one of a text message or a multimedia message;
responding to the account status query request by sending account status information corresponding to the payment request to the first client device, wherein the information corresponding to the payment request includes a balance on the payment request.

10. A server system, comprising:
one or more processors;
memory; and
one or more programs, wherein the one or more programs are stored in the memory and configured to be executed by the one or more processors, the one or more programs including instructions that when executed by the one or more processors cause the server system to:
receive, from a first client device of a respective consumer, a request to establish a prepayment account at the social networking system, wherein the request includes an identifier of a user account of the respective consumer at the social networking system;
in response to the received request, establishing the prepayment account;
receive a payment request from the first client device;
in response to the payment request, generate a unique identifier corresponding to the payment request and send the unique identifier to the first client device;
receive, from a second client device of a respective merchant, a transaction request that includes information corresponding to the unique identifier, a transaction amount, and an identifier of a user account of the respective merchant at the social networking system; and
initiate transfer of the transaction amount from the prepayment account to the user account of the respective merchant at the social networking system.

11. The server system of claim 10, wherein the unique identifier is a barcode.

12. The server system of claim 10, wherein the unique identifier is sent to the first client device by one of a text message or a multimedia message delivered by the social networking system.

13. The server system of claim 10, wherein the instructions further cause the server system to send a verification message to the first client device requesting the user of the first client device's approval of the transaction request.

14. The server system of claim 10, wherein the instructions further cause the server system to verify the identity of a consumer initiating the transaction request by:
receiving, from a respective one of the first client device or the second client device, a payment key entered at the respective one of the first client device or the second client device by the consumer initiating the transaction request;
prior to initiating transfer of the transaction amount from the prepayment account to the user account of the respective merchant, accessing a payment key corresponding to the prepayment account;
determining whether the payment key entered by the consumer initiating the transaction request matches the payment key corresponding to the prepayment account;
wherein initiating transfer of the transaction amount from the prepayment account to the user account of the respective merchant at the social networking system includes:
in accordance with a determination that the payment key entered by the consumer initiating the transaction request matches the payment key corresponding to the prepayment account, transferring the transaction amount from the prepayment account to the user account of the respective merchant; and
in accordance with a determination that the payment key entered by the consumer initiating the transaction request does not match the payment key corresponding to the prepayment account, refusing transfer of the transaction amount from the prepayment account to the user account of the respective merchant.

15. The server system of claim 10, wherein the received payment request includes user designated constraints on transaction requests that invoke the unique identifier; and
the instructions further cause the server system to determine if the received transaction request meets predefined criteria corresponding to the user designated constraints;
wherein initiating transfer of the transaction amount from the prepayment account to the user account of the respective merchant at the social networking system includes:
in accordance with a determination that the received transaction request meets the predefined criteria corresponding to the user designated constraints, transferring the transaction amount from the prepayment account to the user account of the respective merchant; and
in accordance with a determination that the received transaction request does not meet the predefined criteria corresponding to the user designated constraints, refusing transfer of the transaction amount from the prepayment account to the user account of the respective merchant.

16. The server system of claim 15, wherein the user designated constraints include one or more of: a temporal constraint, a geographic constraint, a merchant constraint, or a product category constraint.

17. The server system of claim 10, wherein initiating transfer of the transaction amount from the prepayment account to the user account of the respective merchant at the social networking system includes, upon receiving the transaction request, transferring the transaction amount from the prepayment account to the user account of the respective merchant without delay.

18. The server system of claim 10, wherein the instructions further cause the server system to:
receive, from the first client device, an account status query request through one of a text message or a multimedia message;
respond to the account status query request by sending account status information corresponding to the payment request to the first client device, wherein the information corresponding to the payment request includes a balance on the payment request.

19. A non-transitory computer readable storage medium storing one or more programs, the one or more programs comprising instructions, which when executed by a server system with one or more processors and memory, cause the server system to:
receive, from a first client device of a respective consumer, a request to establish a prepayment account at the social networking system, wherein the request includes an identifier of a user account of the respective consumer at the social networking system;
in response to the received request, establishing the prepayment account;
receive a payment request from the first client device;
in response to the payment request, generate a unique identifier corresponding to the payment request and send the unique identifier to the first client device;
receive, from a second client device of a respective merchant, a transaction request that includes information corresponding to the unique identifier, a transaction amount, and an identifier of a user account of the respective merchant at the social networking system; and
initiate transfer of the transaction amount from the prepayment account to the user account of the respective merchant at the social networking system.

20. The non-transitory computer readable storage medium of claim 19, wherein the instructions further cause the server system to send a verification message to the first client device requesting the user of the first client device's approval of the transaction request.
